(19) United States
(12) Patent Application Publication
(10) Pub. No.: US 2025/0206958 A1
(43) Pub. Date: Jun. 26, 2025

(54) CURABLE COMPOSITION FOR SEALING PROTRUSIONS THROUGH PREAPPLIED WATERPROOFING SYSTEMS

(71) Applicant: GCP Applied Technologies Inc., Malvern, PA (US)

(72) Inventors: David Cozzens, Burlington, MA (US); Xia Cao, Acton, MA (US); Jyoti Seth, Andover, MA (US)

(21) Appl. No.: 19/001,233

(22) Filed: Dec. 24, 2024

Related U.S. Application Data
(60) Provisional application No. 63/614,824, filed on Dec. 26, 2023.

(51) Int. Cl. C09D 4/06; C09D 133/06; C09D 193/04

(52) U.S. Cl. CPC C09D 4/06; C09D 133/066; C09D 193/04

(57) ABSTRACT

A curable waterproofing composition, waterproofing kit, method of use, and building product containing such composition is provided. The curable composition, upon cure, exhibits strong adhesion to the construction surfaces on which it is applied as well as to concrete cast upon the cured curable composition, producing a continuous and fully bonded waterproof system, even though different surfaces and surface textures are presented at the surface-to-surface joinder among various components within a pre-applied waterproofing construction site.

### CROSS-REFERENCE TO RELATED APPLICATION(S)

This application claims priority under 35 U.S.C. § 119(e) to U.S. Provisional Application No. 63/614,824, entitled “CURABLE COMPOSITION FOR SEALING PROTRUSIONS THROUGH PREAPPLIED WATERPROOFING SYSTEMS,” by David COZZENS et al., filed Dec. 26, 2023, which is assigned to the current assignee hereof and incorporated herein by reference in its entirety.

### FIELD OF THE INVENTION

The present invention relates to liquid waterproofing compositions, composition packages, systems, and methods for waterproofing a construction surface and, more particularly, to achieving waterproofing bond with various material surfaces such as concrete, synthetic polymer-containing membranes, and metals in soil retention assemblies having waterproofing membranes.

### BACKGROUND OF THE INVENTION

Pre-applied waterproofing, sometimes called “blind-side” or “reverse tanking” waterproofing, refers to an established practice in which a membrane is positioned against a substrate, such as horizontal or vertical formwork or “lagging,” subsequent to which a fresh concrete is “post-cast” against the membrane to form a building structure (e.g., a foundation) or a civil engineering structure (e.g., tunnel). In other words, waterproofing is installed first, and building is “cast” afterward.

U.S. Pat. No. 5,496,615 of Bartlett et al. discloses a pre-applied waterproofing membrane having a carrier layer (e.g., polymer film), a pressure-sensitive adhesive layer (e.g., non-bituminous), and a protective coating (e.g., dusted particulate layer), against which concrete is “post-cast” to achieve a waterproof bond when cured. In contrast to conventional “post-applied” membranes that are adhered to existing structures, pre-applied waterproofing membranes enable the concrete to be cast and waterproofed in the same operation in relatively tight spaces, such as in urban areas where one building structure might be constructed against another structure.

However, it is necessary to achieve waterproof bonding with post-cast concrete at overlaps and seams between adjacent waterproofing membranes, as well as across concrete joints. Additionally, continuity of a waterproofing barrier is a major challenge when sealing around perforations in a waterproofing membrane due to penetrating objects such as metal pipes, steel rebar, rock anchors, tiebacks, and other plastic or metal objects which present varied surface textures and materials.

In U.S. Pat. No. 8,475,909, Seth et al. disclosed pre-applied waterproofing membranes having three-dimensional, shaped contours useful for reverse-tanking waterproofing of detail areas such as those presented by tiebacks, pipes, pile caps, and other irregularities on concrete formworks. Tiebacks are large assemblies that secure the end of a rod, cable, or screw through waterproofing membrane and formwork to the soil or other adjacent structure against which the formwork is secured. The contoured membranes of Seth et al. were made of polymers that could be thermoformed to have shapes suitable for tiebacks (e.g., domed) or pipes (e.g., cylindrical) or other protrusions, and could employ waterproofing adhesives and protecting coatings similar to those used in the sheet-form membranes disclosed in U.S. Pat. No. 5,496,615 discussed above (See e.g., column 6, lines 17 et seq.). Various pre-applied membranes can be seamed together to provide a coherent waterproofing barrier despite penetrations caused by pipes, tiebacks, and other structures, and two-sided reverse tanking tape could be used to seam membrane components together. Such membranes and two-sided reverse tanking tapes are available from GCP Applied Technologies Inc. (Massachusetts) under the PREPRUFE® brand name.

Liquid applied compositions for dealing with penetration issues would appear to be preferred over tapes and membranes for reasons of speed and convenience, and some have been mentioned in the patent literature concerning pre-applied waterproofing applications. For example, U.S. Publication No. 20120198787A1 describes a method wherein a liquid waterproofing material is sprayed onto backing material which is said to avoid seams that otherwise might be caused by sheet membrane installation that is followed by subsequent application of an adhesion promoting layer. U.S. Publication No. 20200199840A1 describes application of a liquid membrane having a purported greater adhesion to post-cast concrete as compared to adhesion to the lagging wall. U.S. Publication No. 20130059082A1 describes two-part construction sealant compositions that could be cured upon application.

Although liquid compositions have been described in the literature and offered by almost all major pre-applied waterproofing product manufacturers, the present inventors believe that there remains an unmet need for a novel liquid curing composition that can provide excellent bonding with various materials and their surfaces at penetration points: such as concrete surfaces (e.g., the post-cast concrete as well as pre-existing concrete of adjacent walls or structures), metal surfaces (e.g., pipes, steel reinforcing bars, fasteners, screws, etc.), and synthetic polymers (e.g., plastic or polymer carrier sheets of membranes or waterproofing meshes or fleeces). The liquid curing composition needs to exhibit excellent adhesion to these various substances, not only to fill in the cavities and niches of the penetration point and surface irregularities, but also to bond strongly with all of these materials so that a continuous and fully bonded waterproofing system is established with the post-cast concrete, whereby leaks are prevented.

While certain aspects of conventional technologies have been discussed to facilitate disclosure of the invention, Applicants in no way disclaim these technical aspects, and it is contemplated that the claimed invention may encompass one or more of the conventional technical aspects discussed herein.

The present invention may address one or more of the problems and deficiencies of the prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

In this specification, where a document, act, or item of knowledge is referred to or discussed, this reference or discussion is not an admission that the document, act, or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

### SUMMARY OF THE INVENTION

The long-standing but heretofore unfulfilled need for an improved liquid curing composition for below-grade pre-applied waterproofing is now met by a new, useful, and nonobvious invention.

In one aspect, disclosed herein is a curable composition includes: at least one first acrylate monomer; at least one second acrylate monomer; at least one tackifying agent in an amount of at least 20 wt. % and no greater than 75 wt. %, based on the total weight of the curable composition; and at least one polymerization initiator; wherein a homopolymer of the at least one first acrylate monomer has a higher glass transition temperature than a respective glass transition temperature of a homopolymer of the at least one second acrylate monomer, and wherein the curable composition has at least one of the following:
(i) a weight percent ratio of the at least one first acrylate monomer to the at least one second acrylate monomer in a range from 1:1 to 1:5, and/or
(ii) the at least one first acrylate monomer present in an amount of 5-30 wt. % and the at least one second acrylate monomer in an amount of 20-45 wt. % based on the total weight of the curable composition.

In another aspect, a method of waterproofing a construction surface is provided. The method includes: a. applying a liquid layer of the curable composition, as disclosed hereinabove, over the construction surface; b. allowing the curable composition to cure, to form a solid waterproofing layer; c. applying a layer of a hydratable cementitious composition over the waterproofing layer and hardening the hydratable cementitious composition to form a hardened concrete, wherein a peel adhesion between the hardened concrete and the waterproofing layer is from 3.0 to 50.0 pounds per linear inch (pli) or 0.525 to 8.756 Newtons per mm according to modified ASTM D903-98 (2017), as described in the Examples.

In another aspect, a waterproofing kit is provided. The waterproofing kit includes a first composition; and a second composition, wherein the first composition and/or the second composition include at least one first acrylate monomer, at least one second acrylate monomer, at least one tackifying agent in an amount of at least 20 wt. % and no greater than 75 wt. %, based on the total weight of the curable composition, and wherein a homopolymer of the at least one first acrylate monomer has a higher glass transition temperature than a respective glass transition temperature of a homopolymer of the at least one second acrylate monomer, and a weight percent ratio of the at least one first acrylate monomer to the at least one second acrylate monomer ranges from 1:1 to 1:5; wherein a curable composition, formed by mixing a portion of the first composition and a portion of the second composition, has at least one of the following:
(i) a weight percent ratio of the at least one first acrylate monomer to the at least one second acrylate monomer ranges from 1:1 to 1:5, and/or
(ii) the at least one first acrylate monomer present in an amount of 5-30 wt. % and the at least one second acrylate monomer in an amount of 20-45 wt. % based on the total weight of the curable composition, and wherein the first composition comprises a polymerization initiator, and the second composition is essentially free of the polymerization initiator.

In yet another aspect, disclosed herein is a waterproofing article comprising a waterproofing layer disposed over at least a portion of a barrier layer, wherein the waterproofing layer is formed of the cured curable composition as disclosed hereinabove, and wherein the barrier layer is configured to provide moisture and/or vapor barrier.

The embodiments of the invention can be used alone or in combination with each other.

### BRIEF DESCRIPTION OF THE DRAWINGS

A greater appreciation of the benefits and features of the present invention may be more readily comprehended when the following written description of exemplary embodiments is considered in conjunction with the drawings, wherein:

FIG. 1 is a diagrammatic illustration of an exemplary method and system according to embodiments of the present invention, wherein a curable composition according to embodiments of the present invention is applied to a perforation in a waterproofing membrane installed on a construction substrate, such as a lagging formwork.

FIG. 2 is a schematic illustration of a cross-sectional view of an exemplary waterproofing article according to embodiments of the present invention.

FIG. 3 is a schematic illustration of a cross-sectional view of another exemplary waterproofing article according to embodiments of the present invention.

### DETAILED DESCRIPTION OF EXEMPLARY EMBODIMENTS

In the following detailed description of the preferred embodiments, reference is made to the accompanying drawings, which form a part thereof, and within which are shown by way of illustration specific embodiments by which the invention may be practiced. It is to be understood that other embodiments may be utilized, and structural changes may be made without departing from the scope of the invention.

The waterproofing systems described herein are intended to bond with fresh cementitious compositions that are cast against them and allowed to harden. Cementitious compositions, such as concrete or mortar cement, which are applied this way to the waterproofing layer or waterproofing membranes, are sometimes referred to as being “post cast” or “post applied.” As used herein, “waterproofing layer” refers to a layer of cured curable composition according to various embodiments of the present invention. As used herein, the term “waterproofing membrane” may include a waterproofing layer, formed from curing the curable composition of the present invention, disposed over a barrier layer. Alternatively, the “waterproofing membrane” may comprise a multi-layer structure onto which a waterproofing layer, formed from curing the curable composition of the present invention, is applied.

The terms “cement,” “cementitious composition,” and “hydratable cementitious composition” are used herein interchangeably to refer to dry powders as well as to pastes, mortars, grouts, and concrete compositions comprising a hydratable cement binder. The terms “paste”, “mortar” and “concrete” are terms of art: pastes are mixtures composed of a hydratable cement binder (usually, but not exclusively, Portland cement, masonry cement, or mortar cement). Mortars are pastes additionally including fine aggregate (e.g., sand), and concrete are mortars additionally including coarse aggregate (e.g., crushed gravel, stone). Cementitious compositions are typically formed by mixing hydratable cement, water, and fine and/or coarse aggregate.

As used in this specification and the appended claims, the singular forms “a”, “an”, and “the” include plural referents unless the content clearly dictates otherwise. As used in this specification and the appended claims, the term “or” is generally employed in its sense including “and/or” unless the context clearly dictates otherwise.

As used herein, “about” means approximately or nearly and in the context of a numerical value or range set forth means±15% of the numerical. In exemplary embodiments, the term “about” can include traditional rounding according to significant figures of the numerical value. In addition, the phrase “about ‘x’ to ‘y’” includes “about ‘x’ to about ‘y’”.

Further, any range of numbers recited in the specification or claims, such as that representing a particular set of properties, units of measure, conditions, physical states or percentages, is intended to literally incorporate expressly herein by reference or otherwise, any number falling within such range, including any subset of numbers within any range so recited. For example, whenever a numerical range with a lower limit, RL, and an upper limit RU, is disclosed, any number R falling within the range is specifically disclosed. In particular, the following numbers R within the range are specifically disclosed: R=RL+k(RU−RL), where k is a variable ranging from 1% to 100% with a 1% increment, e.g., k is 1%, 2%, 3%, 4%, 5% , . . . 50%, 51%, 52% . . . 95%, 96%, 97%, 98%, 99%, or 100%. Moreover, any numerical range represented by any two values of R, as calculated above, is also specifically disclosed.

Disclosed herein is a curable composition including at least one first acrylate monomer; at least one second acrylate monomer; at least one tackifying agent in an amount of at least 20 wt. % and no greater than 75 wt. %, based on the total weight of the curable composition, wherein a homopolymer of the at least one first acrylate monomer has a higher glass transition temperature than a respective glass transition temperature of a homopolymer of the at least one second acrylate monomer. The curable composition has at least one of the following:
(i) a weight percent ratio of the at least one first acrylate monomer to the at least one second acrylate monomer in a range from 1:1 to 1:5, and/or
(ii) the at least one first acrylate monomer present in an amount of 5-30 wt. % and the at least one second acrylate monomer in an amount of 20-45 wt. % based on the total weight of the curable composition.

At least one first acrylate monomer is used to make the curable composition. An acrylate refers to a chemical group that includes a carbon-carbon double bond that is bonded to an ester functional group (—COOR), where R includes an alkyl group, an aromatic group, an alcohol, a cycloalkane group, a heterocyclic group, a bicyclic group, any combination thereof, and the like. Any acrylate monomer is envisioned. In an embodiment, the at least one first acrylate monomer includes any number of functionalities. In a particular embodiment, the at least one first acrylate monomer is a mono-functional acrylate monomer. In an example, the at least one first acrylate monomer is an aliphatic acrylate monomer. Exemplary acrylate monomers for the at least one first acrylate monomer include, but are not limited to 2-hydroxypropyl methacrylate, 2-hydroxyethyl methacrylate, methyl methacrylate, isobornyl methacrylate, tetrahydrofurfuryl methacrylate, benzyl methacrylate, isophoryl methacrylate, cyclohexyl methacrylate, or any combination thereof. In a particular embodiment, the at least one first acrylate monomer is 2-hydroxypropyl methacrylate.

Any amount of the at least one first acrylate monomer is envisioned and is dependent on the properties desired for the curable composition. For instance, the at least one first acrylate monomer may be present in an amount of 5-30 wt. % based on the total weight of the curable composition. In an embodiment, the amount of the at least one first acrylate monomer is at least 7 wt. %, or at least 10 wt. %, or at least 12 wt. %, or at least 15 wt. %, or at least 18 wt. % based on the total weight of the curable composition. In an embodiment, the amount of the at least one first acrylate monomer is not greater than 19 wt. %, or not greater than 17 wt. %, or not greater than 15 wt. %, or not greater than 13 wt. % based on the total weight of the curable composition.

The at least one first acrylate monomer typically has an advantageous glass transition temperature to provide for a desirable curable composition. For instance, a homopolymer of the at least one first acrylate monomer has a glass transition temperature that is higher than a respective glass transition temperature of a homopolymer of the at least one second acrylate monomer. Any glass transition temperature is envisioned for the homopolymer of the at least one first acrylate monomer with the proviso that it is higher than the respective glass transition temperature of the homopolymer of the at least one second acrylate monomer. In an embodiment, the glass transition temperature of the homopolymer of at least one first acrylate monomer is at least 20° C., or at least 25° C., or at least 30° C., or at least 35° C., or at least 40° C., or at least 50° C., or at least 60° C. Further, the glass transition temperature of the homopolymer of the at least one first acrylate monomer is not greater than 150° C., or not greater than 140° C., or not greater than 130° C., or not greater than 120° C. “A homopolymer” as used herein refers to a polymer wherein all the monomer units are the same.

Glass transition temperature is a temperature range below which an amorphous material exhibits glassy mechanical behavior, and above which the material exhibits rubbery mechanical behavior. Reported glass transition temperature can vary slightly depending on the method of measurement and definition. For the present invention, glass transition temperature is defined as the midpoint glass transition temperature, T_{mg}, measured by differential scanning calorimetry according to ASTM D3418-21.

The viscosity of the at least one first acrylate monomer of the present invention is typically 0.1 mPa·s to 30 mPa·s, more typically 1.0 mPa·s to 28 mPa·s, even typically 1.0 mPa·s to 20 mPa·s measured according to ASTM D4889-21(2021), Method A. In the case where the viscosity is greater than 30 mPa·s, a curable composition has a high viscosity, lowered workability, and could have undesirable curing in some cases.

At least one second acrylate monomer is used to make the curable composition. Any acrylate monomer is envisioned, with the proviso that it has a lower respective homopolymer glass transition temperature than the at least one first acrylate monomer. In an embodiment, the at least one second acrylate monomer includes any number of functionalities. For instance, the at least one second acrylate monomer is a mono-functional acrylate monomer. In an embodiment, the at least second acrylate monomer includes a chemical group that includes a carbon-carbon double bond that is bonded to an ester functional group (—COOR), where R includes an alkyl group, an aromatic group, an alcohol, a cycloalkane group, a heterocyclic group, a bicyclic group, or any combination thereof. In an example, the at least one second acrylate monomer is an aliphatic acrylate monomer. Exemplary acrylate monomers as the at least one second acrylate monomer include, but are not limited to dodecyl methacrylate, isodecyl methacrylate, 2-ethylhexylacrylate, 2-ethylhexyl methacrylate, ethyltriglycol methacrylate, 2 phenoxyethyl methacrylate, or any combination thereof. In a particular embodiment, the at least one second acrylate monomer is dodecyl methacrylate.

Any amount of the at least one second acrylate monomer is envisioned and is dependent on the properties desired for the curable composition. For instance, the at least one second acrylate monomer may be present in an amount of 20-45 wt. % based on the total weight of the curable composition. In an embodiment, the amount of the at least one second monomer is at least 27 wt. % based on the total weight if the curable composition, or at least 30 wt. %, or at least 35 wt. %, or at least 38 wt. %, or at least 40 wt. % based on the total weight of the curable composition. In an embodiment, the amount of the at least one second acrylate monomer is not greater than 43 wt. % based on the total weight of the curable composition, or not greater than 40 wt. %, or not greater than 38 wt. %, or not greater than 35 wt. %, or not greater than 33 wt. %, or not greater than 30 wt. % based on the total weight of the curable composition.

In an exemplary embodiment, the at least one second acrylate monomer typically has an advantageous glass transition temperature to provide for a desirable curable composition. For instance, the homopolymer of the at least one second acrylate monomer has a respective glass transition temperature that is lower than the glass transition temperature of the homopolymer of the at least one first acrylate monomer. Any glass transition temperature is envisioned for the homopolymer of the at least one second acrylate monomer with the proviso that it is less than the respective glass transition temperature of the homopolymer of the at least one first acrylate monomer. In an embodiment, the respective glass transition temperature of the homopolymer of the at least one second acrylate monomer is not greater than 18° C., or not greater than 15° C., or not greater than 10° C., or not greater than 5° C., or not greater than 0° C., or not greater than −10° C., or not greater than −20° C., or not greater than −30° C., or not greater than −40° C. Further, the respective homopolymer glass transition temperature of the second acrylate monomer is at least −90° C., or at least −80° C., or at least −70° C., or at least −50° C.

The viscosity of the at least one second acrylate monomer of the present invention is typically 0.1 mPa·s to 30 mPa·s, more typically 1.0 mPa·s to 28 mPa·s, even typically 1.0 mPa·s to 20 mPa·s measured according to ASTM D4889-21(2021), Method A. In the case where the viscosity is greater than 30 mPa·s, a curable composition has a high viscosity, lowered workability, and could have undesirable curing in some cases.

The weight percent ratio of the at least one first acrylate monomer to the at least one second acrylate monomer can be tailored depending on the properties desired for the curable composition. Any weight percent ratio is envisioned, taking into consideration properties such as adhesion, cure time, reactivity, adhesion rheology, temperature at time of cure, the like, or any combination thereof. In an embodiment, the weight percent ratio of the at least one first acrylate monomer to the at least one second acrylate monomer ranges from 1:1 to 1:5.

In a particular embodiment, a weight ratio of the at least one second acrylate monomer to the at least one first acrylate monomer is greater than or equal to 1, or at least 1.2, or at least 1.2, or at least 1.3, or at least 1.4, or at least 1.5, or at least 1.7, or at least 2.0, or at least 2.5, or at least 3.0. In a particular embodiment, the ratio of the at least one second acrylate monomer to the at least one first acrylate monomer is not greater than 5.0, or not greater than 4.8, or not greater than 4.6, or not greater than 4.5, or not greater than 4.0, or not greater than 3.5, or not greater than 3.0, or not greater than 2.5, or not greater than 2.2.

Further included in the curable composition is at least one tackifying agent. Within the context of the present disclosure, the term “tackifier” refers to a compound that is incorporated into the composition and increases tack of the cured membrane. Any tackifying agent is envisioned that is miscible in the acrylate monomers and provides desirable adhesion to post-cast concrete. In particular, the tackifying agent is soluble at room temperature. Tackifiers well known in the art include a hydrocarbon resin, such as a C5 aliphatic resin, a C9 aromatic resin, a gum rosin, a rosin acid, a rosin ester, a hydrogenated resin of the above, and the like.

In an embodiment, the tackifying agent includes a gum rosin, a hydrocarbon resin, or combination thereof. In a more particular embodiment, the tackifying agent includes a glycerol ester of gum rosin, a pentaerythritol ester of gum rosin, a methyl ester of gum rosin, an aromatic hydrocarbon resin, an aliphatic hydrocarbon resin, a mixed aliphatic/aromatic resin, a terpene resin, or any combination thereof. In a more particular embodiment, the tackifying agent is the glycerol ester of gum rosin. In an exemplary embodiment, the tackifying agent consists essentially of the glycerol ester of gum rosin.

Any amount of tackifying agent is envisioned and is dependent on the properties desired for the curable composition. For instance, the at least one tackifying agent may be present in an amount of at least 20 wt. % based on the total weight of the curable composition. In an embodiment, the amount of the at least one tackifying agent is at least 25 wt. %, or at least 33 wt. %, or at least 35 wt. %, or at least 38 wt. %, or at least 40 wt. % based on the total weight of the curable composition. In an embodiment, the amount of the at least one tackifying agent is not greater than 75 wt. %, or not greater than 60 wt. %, or not greater than 50 wt. %, or not greater than 45 wt. %, or not greater than 42 wt. %, or not greater than 40 wt. %, or not greater than 37 wt. % based on the total weight of the curable composition.

The curable composition may further include any additive envisioned, depending on the final properties desired. In an embodiment, the additive includes a wax. A wax forms a barrier at the surface of the applied liquid layer and prevents reactive oxygen species in air from prematurely quenching polymerization. Any wax is envisioned and includes, for example, a microcrystalline wax, an alpha olefin wax, a paraffin wax, or any combination thereof. The wax may be present at an amount of at least 0.3 wt. %, or at least 0.5 wt. %, or at least 0.8 wt. %, or at least 1.0 wt. %, based on the total weight of the curable composition. In an embodiment, the amount of the wax is not greater than 3.0 wt. % based on the total weight of the curable composition, or not greater than 2.5 wt. %, or not greater than 2.0 wt. %, or not greater than 1.5 wt. %, or not greater than 1.0 wt. %, based on the total weight of the curable composition.

Further additives include a light stabilizer, a UV absorber, a polymerization initiator, an accelerator, a pigment, a dispersant, an antioxidant, a defoamer, a rheology modifier, a plasticizer, the like, or combination thereof. A light stabilizer is an additive used to resist degradation caused by UV exposure by scavenging radicals. Any light stabilizer is envisioned and includes, for example, a hindered amine. A UV absorber is an additive that absorbs UV radiation in place of the binder or polymer system. Any UV absorber is envisioned and includes, for example, hydroxyphenyl benzotriazole. Any plasticizer is envisioned and refers to a compound that is incorporated into the composition and reduces the modulus of the cured membrane. Plasticizers well known in the art include, for example, an organic ester, an oil, a low T_{g} oligomer, and the like.

Any polymerization initiator is envisioned that and includes, for example, benzoyl peroxide, methyl ethyl ketone peroxide, dibenzoyl peroxide, acetylacetone peroxide, and tert-butyl peroxy-3,5,5-trimethyl hexanoate, t-butyl peroctoate, t-butyl perbenzoate, cumene hydroperoxide, other peroxides, or any combination thereof. A polymerization initiator is a compound responsible for generating the radical species from which the polymerization proceeds. Radical generation can proceed in the absence or presence of an accelerator. Any accelerator is envisioned that increases the speed of the cure and includes, for example, an aromatic tertiary amine, cobalt naphthenate, cobalt octoate, dimethylaniline, or any combination thereof. An accelerator is a compound which facilitates radical generation in conjunction with the initiator so that polymerization proceeds and is completed within a practical timeframe. Any aromatic tertiary amine is envisioned and includes but is not limited to diisopropanol-p-toluidine, dimethyl-p-toluidine, or N-(2-hydroxyethyl)-N-methyl-p-toluidine. In an embodiment, the curing composition is substantially free of accelerator and curing, the initiation of polymerization, is light or thermally activated.

In another embodiment, the polymerization initiator is a photoinitiator. Polymerization photoinitiators include Norrish Type 1 and Type 2 photoinitiators such as aromatic or alkyl phenones, phosphine oxides, and anthroquinones. Examples of a polymerization photoinitiator include but are not limited to acetophenone, benzophenone, 1-hydroxycyclohexyl phenyl ketone, 4,4′-Bis(dimethylamino)benzophenone, phenylbis(2,4,6-trimethylbenzoyl)phosphine oxide, thioxanthen-9-one, and the like.

In an embodiment, the curable composition is substantially free of a filler, such as titanium dioxide, calcium carbonate, diatomite, or combination thereof. “Substantially free” as used herein refers to less than 1.0 wt. %, less than 0.5 wt. %, less than 0.1 wt. %, or 0 wt. %, based on the total weight of the curable composition.

In the present invention, a combination-product, such as a waterproofing kit, for preparing a curable composition is provided. In an example, the waterproofing kit includes a first component including a first composition and a second component including a second composition. The first composition and/or the second composition includes the at one first acrylate monomer, the at least one second acrylate monomer, and the at least one tackifying agent. In a particular embodiment, the first composition includes a polymerization initiator, such as benzoyl peroxide, and the second composition includes the at least one first acrylate monomer, the at least one second acrylate monomer, and the at least one tackifying agent. In a more particular embodiment, the second composition further includes an accelerator. In an embodiment the second composition is substantially free of a polymerization initiator. When mixed together, the first composition and the second composition react and initiate curing of the curable composition. In another embodiment, the first composition and the second composition are substantially free of accelerator and when mixed together do not substantially react until exposed to light or heat for curing of the curable composition.

In another example, the first composition includes the polymerization initiator, such as benzoyl peroxide and the second composition includes the at one first acrylate monomer, the at least one second acrylate monomer, and the at least one tackifying agent. A third composition may be present and include at least one first acrylate monomer, at least one second acrylate monomer, at least one tackifying agent, and an accelerator. The first composition and second composition could be mixed together to form a mixture and the third composition applied to the mixture to initiate curing. Any order of mixing may be envisioned. Any number of compositions is envisioned. Further, any combination of components in the first composition and/or second composition and/or additional compositions is envisioned to separate the components that will cure when mixed together.

The separate parts of the exemplary composition package as described above are preferably shipped (in separate containers or packages) to the installation or job site, where they are combined (such as by spraying through a single nozzle where they are conveniently mixed together), and applied onto the base of the object penetrating through or protruding out of a pre-applied waterproofing membrane to form a waterproofing seal, after which the coating begins to harden and form a waterproofing layer. The kit may further include instructions for forming the curable composition.

Further disclosed is a method of waterproofing a construction surface. For instance, the method may include integrating a pre-applied waterproofing membrane installed against any vertical or horizontal construction surface. The construction surface may include, but is not limited to a soil retention structure and/or base slab. In an embodiment, the construction surface has at least one article protruding out of the construction surface and/or penetrating through the pre-applied waterproofing membrane. The method of waterproofing the construction surface includes the steps of: a. applying a liquid layer of the curable composition, as disclosed hereinabove, adjacent to a properly prepared soil retention structure and/or base slab, such as over the construction surface; b. allowing the curable composition to cure, to form a solid waterproofing layer; c. applying a layer of a hydratable cementitious composition, also generally known as wet concrete, over the waterproofing membrane and hardening the hydratable cementitious composition to form a hardened concrete, wherein a peel adhesion between the hardened concrete and the waterproofing layer is from 3.0 to 50.0 pounds per linear inch (pli) or 0.525 to 8.756 Newtons per mm according to modified ASTM D903-98 (2017). In some embodiments, the step of applying a layer of hydratable cementitious composition includes applying shotcrete or cast-in-place concrete.

In some embodiments, the soil-retention system is selected from the group consisting of lagging, formwork, shotcrete, a diaphragm wall, the like, or combination thereof. In an embodiment, the base slab is selected from the group consisting of a mud slab, a concrete slab, a protection slab, crushed stone, the like, or combination thereof. “A properly prepared” soil retention structure and/or base slab is a structure that is prepared for liquid application, including but not limited to a waterproofing membrane, or other of material such as sheet, fabric, foam, regulating layer, the like, or combination thereof to smooth the surface of the retention structure and/or base slab.

The method disclosed herein may further include a construction surface that includes the at least one article protruding out of the construction surface, and wherein the step of applying a liquid layer of the curable composition over the construction surface further includes applying the liquid layer of the curable composition at a base of the at least one article protruding. In an embodiment, the article is selected from the group that includes, but is not limited to, a pipe, a steel reinforcement bar, a rock anchor, a screw, or any combination thereof. In an embodiment, the construction surface may further include a barrier layer disposed over the construction surface and wherein the step of applying a liquid layer of the curable composition includes applying the liquid layer of the curable composition over a surface of the barrier film. Any reasonable material is envisioned for the barrier layer and includes, but is not limited to, a polyolefin, a polyester, a polyurethane, a styrenic block copolymer, a silicone, an ethylene-propylene diene monomer (EPDM), a geotextile, a bituminous composite, or a combination thereof. In an embodiment, the barrier layer is a foam including a polyolefin, a polyester, a polyurethane, a polystyrene, an acrylic, a styrenic block copolymer, a silicone, a bituminous composite, or a combination thereof.

According to the “reverse tanking” waterproofing technique, a waterproofing membrane is first attached with the back side of its carrier sheet against a “formwork” (i.e., concrete mold usually formed by wooden boards joined together). Consequently, the waterproofing adhesive layer faces outwards. A concrete structure is created by casting concrete against the membrane-covered formwork surface, and this may be referred to as “post cast” or “post applied” concrete. In an embodiment, the adhesive layer is covered by an elastomeric protective coating layer, a particle coating layer, or mixture or arrangement of both (i.e., either individually, mixed together as one layer, or arranged as discrete layers), to protect the adhesive from dirt and damage. This protective coating layer (whether polymeric or particle coating) also operates to decrease the tack of the adhesive. The outer surface is further protected by a release sheet liner (that must be removed before fresh concrete is poured against the adhesive/protective coating layers). After curing, the concrete is bonded with the adhesive/protective coating layers, and thus a waterproofing bond is achieved in “reverse” order.

Hence, in the world of “reverse tanking” waterproofing, it can be said that the waterproofing is “pre-applied” because it precedes the concrete structure; and, in turn, the concrete is said to be “post cast” or “post applied” because it follows the installation of waterproofing.

Reverse tanking is further discussed in U.S. Pat. Nos. 5,496,615 and 6,500,520 which teach using particle coating layers. In the ′615 patent, inorganic particles are used to resist foot traffic when the membrane is installed on a horizontal surface. In the ′520 patent, particles are applied on top of an adhesive layer to enhance bonding with concrete by reacting with calcium hydroxide generated during the hydration of cement.

One of the difficulties of reverse tanking is achieving continuity of waterproofing in detail areas (i.e., surface irregularities), and especially in “tieback” detailing. Tiebacks are the terminal ends of rods or cables supporting the formwork and are found protruding at intervals through the formwork surface. Other surface irregularities include penetration areas, such as where pipes or pile caps extend through the formwork. Common surface irregularities are found in soil-retention systems such as any one of lagging, formwork, shotcrete, mud slabs, or crushed stone against which is disposed or attached a plurality of waterproofing membranes having a synthetic polymer sheet, nonwoven, or mesh sheet-like body or synthetic polymer pressure-sensitive adhesive; and the plurality of sheet-like waterproofing membranes having at least two penetrations from articles chosen from pipe, steel reinforcement bar, rock anchor, a screw, a pile cap, a concrete column, the like, or any combination thereof.

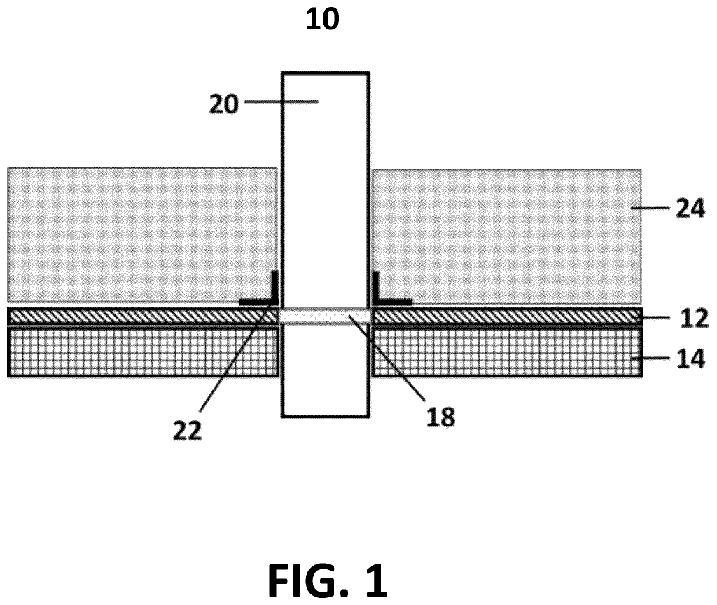

FIG. 1 illustrates an exemplary system 10 including penetrating objects that can be waterproofed by the curable composition disclosed herein. In system 10, at least one and, more preferably, a plurality of waterproofing membranes 12 are attached or fastened to a lagging formwork 14. For ease of illustration, one example waterproofing membrane 12 is shown, having at least one perforation 18 through which a metal structure 20 extends (i.e., at least one penetration). The metal structure 20 can be a pipe, steel reinforcing bar (“rebar”), fastener, a rock anchor, screws, tie-back, or other object. Exemplary waterproofing curing composition 22 of the present invention coating/liquid layer is applied at the penetration area to bond with the membrane 12, with the metal structure 20, and with post-cast concrete 24 and upon curing forms a waterproofing layer.

Any suitable waterproofing membrane 12 may be used. The waterproofing membrane can be any waterproofing single or multi-layer membrane known to those skilled in the art such as, for example, those disclosed in U.S. Pat. Nos. 8,475,909 and 10,267,049 as well as products sold under the PREPRUFE® brand name by GCP Applied Technologies, Inc. In an embodiment, the waterproofing membrane 12 may include a waterproofing layer, formed from curing the curable composition of the present invention, disposed over a barrier layer. In another embodiment, the waterproofing membrane 12 may comprise a multi-layer structure onto which a waterproofing layer, formed from curing the curable composition of the present invention, is applied.

Referring to FIG. 1, once cured, the curable composition forms a membrane 22 around the object penetrating through the pre-applied waterproofing membrane to seal and waterproof the base of the penetrating or protruding object where it intersects with the pre-applied waterproofing membrane. In some embodiments, the liquid layer of the curable composition is applied at an average thickness of from 0.5 to 50 mm. In other embodiments, the liquid layer of the curable composition is applied at an average thickness of from 1 to 25 mm. Although described as being applied to a protruding object, the curable composition can be applied to waterproof any construction surface envisioned.

Components of the curable composition can be applied by any means known in the art. In an embodiment, the components of the curable composition are applied by spray-coating. As used herein, the term “spray-coating” means establishing a coating layer onto a substrate, such as a pre-applied waterproofing membrane and an object penetrating through, a composition that hardens into a membrane. The spray-coating is typically done by spraying two parts of the composition which are blended within the spray-nozzle or piping or tubing or other conduit that feeds coating composition components from storage containers or tanks to the spray nozzle. The use of two-component systems in spray applications is known in the art.

By “hardened”, those having skill in the waterproofing of buildings and construction will understand that the waterproofing membrane/seal should be dry to hand touch and should not displace (in the manner of a liquid) when spray-applied onto the substrate.

The curable compositions provide for excellent bonding among components used for establishing a monolithic barrier in a pre-applied waterproofing construction application, even if varied materials, surfaces, and surface texturing are involved, and especially where seams and penetrations occur and various surfaces of waterproofing membranes, pipes and other conduits, rebar, and other materials come into contact.

Embodiments of the current invention provide a beneficial combination of properties, for example, the curable composition exhibits adhesion to both a plastic substrate and post-cast concrete, such that it could be applied directly onto a waterproof sheet and produce a layer that is operative to bond to both the waterproofing membrane and provide the unique bond to post-cast concrete.

The waterproofing layer of the cured composition has desirable properties. For instance, the waterproofing layer has a desirable hardness. For instance, the shore A hardness is in a range of 15 to 95, such as 25 to 95, or even 28 to 95, as measured by ASTM D2240-15(2021). The shore A hardness is an indicator of a flexible material.

The method of the present invention includes the step of applying concrete against the pre-applied waterproofing membrane and around the at least one penetration sealed by the curable composition and allowing the concrete to harden against and adhere to the membranes and the curable composition as disclosed hereinabove, wherein the peel adhesion between the hardened concrete and cured acrylate composition is from 3.0 to 50.0 pounds per linear inch (pli) or 0.525 to 8.756 Newtons per mm according to modified ASTM D903-98 (2017), as described in the Examples. This adhesion functions to resist water migration in the event that water reaches the concrete-membrane interface. The waterproofing layer may have a suitable thickness such as from 0.5 to 50 mm.

In one embodiment, upon curing, the cured composition exhibits an adhesion greater than 3 to 50 pounds per linear inch (pli) or 3 to 75 pli, or 3 to 60 pli, 3 to 50 pli, or 5-25 pli, according to modified ASTM D903-98(2017) to the concrete cast against it. In another embodiment, upon curing, the cured composition exhibits an adhesion >3 pli or 3 to 100 pli, or 3 to 75 pli, or 3 to 60 pli, 3 to 50 pli, or 5 to 40 pli, according to ASTM D903-98(2017) to the construction surface on which it is applied, wherein the construction surface is selected from among concrete, metal, polyolefin, a polyester, a polyurethane, a polystyrene, an acrylic, a styrenic block copolymer, a silicone, polyvinylchloride, ethylene propylene diene monomer, a geotextile, or a bituminous composite.

The method of the present invention can be used to waterproof below-grade structures.

The cured curing composition disclosed herein can be used in a variety of ways when acting as a barrier to water, air, and/or vapor. When functioning as a waterproofing layer, it is typically applied as a detailing layer such as at overlaps, seams, pipe or rebar penetrations, or other high-risk areas for water penetration—due in part to its liquid application. As a detailing layer, the curing composition as disclosed hereinabove, can function in conjunction with other waterproofing membranes, such as GCP's PREPRUFE® membranes.

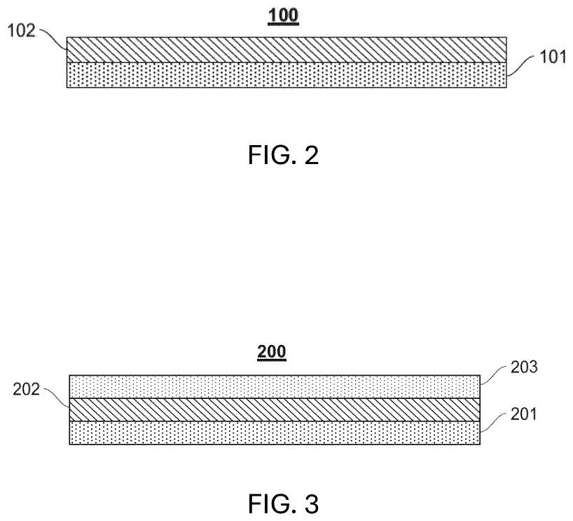

In a particular embodiment and as shown in FIG. 2, the cured curing composition may be used as part of a waterproofing article 100 where the cured curing composition is a waterproofing layer 102 that is disposed over a first functional layer, such as a barrier layer 101, the barrier layer 101 configured to provide moisture barrier, a vapor barrier, or a combination thereof. The waterproofing article may include any other layers envisioned. In an embodiment and as shown in FIG. 3, a waterproofing article 200 includes a particulate layer 203 disposed on at least a portion of the waterproofing layer 202 on a side opposite a barrier layer 201.

In an embodiment, the particulate layer 203 includes a particulate material embedded in a surface of the waterproofing layer 202. In embodiments, the particulate materials may be at least partially embedded in and partially protruding from a top surface of the waterproofing layer 202. The particulate material can include granules, sand, a swellable clay, cement, hydrated cement, limestone, slag fly ash or a combination thereof. The particulate materials may further include a functional coating. The particulate material can have a median particle size of at least 10 microns and no greater than 5000 microns or at least 100 microns and no greater than 1000 microns. Particle sizes of particulate materials may be measured with light scattering using 405 and 650 nm light source with a Horiba LA-950v2 detector.

In an embodiment, the particulate material may have a particular coating density that may provide improved performance and/or manufacturing of the waterproofing article. In an embodiment, the coating density of the particulate material can be at least 0.01 lbs/sq ft. or at least 0.02 lbs/sq ft. or at least 0.03 lbs/sq ft. or at least 0.04 lbs/sq ft. or at least 0.05 lbs/sq ft. In an embodiment the coating density of the particulate material can be no greater than 0.6 lbs/sq ft. or no greater than 0.5 lbs/sq ft. or no greater than 0.4 lbs/sq ft. In an embodiment the coating density of the particulate material can be in the range of 0.01 lbs/sq ft. to 0.6 lbs/sq ft., or 0.03 lbs/sq ft. or to 0.5 lbs/sq ft., or 0.05 lbs/sq ft. to 0.4 lbs/sq ft.

In an embodiment, a top surface 208 of the front side of the waterproofing article 200 may have a particular reflectivity that may facilitate improved performance and/or manufacturing of the waterproofing article. In an embodiment, the top surface of the waterproofing layer 202 may have a reflectivity of at least 5% or at least 10% or at least 15% or at least 20% or at least 25% or at least 30% or at least 35% or at least 40% or at least 45% or at least 50% or at least 55% or at least 60% or at least 65% or at least 70% or at least 75% or at least 80% or at least 85% or at least 90% or at least 95%. In an embodiment, the top surface may have a reflectivity of not greater than 95% or not greater than 90% or not greater than 85% or not greater than 80% or not greater than 75% or not greater than 70% or not greater than 65% or not greater than 60% or not greater than 55% or not greater than 50% or not greater than 45% or not greater than 40% or not greater than 35% or not greater than 30% or not greater than 25% or not greater than 20% or not greater than 15% or not greater than 10% or not greater than 5%. It will be appreciated that the reflectivity may be between any of the minimum and maximum values noted above, including for example, but not limited to, at least 5% and not greater than 95% or at least 15% and not greater than 50%. Reflectivity can be measured with a NOVO-SHADE 45/0 Reflectometer. The test surface is illuminated from a 450 angle and the intensity of scattered light at the perpendicular (i.e., 0°) is measured. Data is recorded on a grey scale where black is 0% and white is 100%. Only shading is measured, irrespective of color, and is referred to as % whiteness.

In an embodiment, the waterproofing article has a peel adhesion between a hardened concrete and the waterproofing layer in a range from 3.0 to 50.0 pounds per linear inch (pli) or 0.525 to 8.756 Newtons per mm according to modified ASTM D903-98 (2017), wherein a wet concrete is first applied over the waterproofing layer, which is subsequently hardened to form the hardened concrete. In an embodiment, the wet concrete is applied over the particulate layer 203. In another embodiment, the wet concrete is applied over the waterproofing layer 202, where the waterproofing article has no particulate layer.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the items as listed below.

Embodiment 1. A curable composition includes: at least one first acrylate monomer in an amount of 5-30 wt. % based on the total weight of the curable composition; at least one second acrylate monomer in an amount of 20-45 wt. % based on the total weight of the curable composition; at least one tackifying agent in an amount of at least 20 wt. % based on the total weight of the curable composition; and at least one polymerization initiator wherein a homopolymer of the at least one first acrylate monomer has a higher glass transition temperature than a respective glass transition temperature of a homopolymer of the at least one second acrylate monomer.

Embodiment 2. A curable composition includes: at least one first acrylate monomer; at least one second acrylate monomer; at least one tackifying agent in an amount of at least 20 wt. % based on the total weight of the curable composition, and at least one polymerization initiator; wherein a homopolymer of the at least one first acrylate monomer has a higher glass transition temperature than a respective glass transition temperature of a homopolymer of the at least one second acrylate monomer, and a weight percent ratio of the at least one first monomer to the at least one second monomer ranges from 1:1 to 1:5.

Embodiment 3. The curable composition of embodiments 1 or 2, wherein the at least one first acrylate monomer is a mono-functional acrylate monomer.

Embodiment 4. The curable composition of any one of the preceding embodiments, wherein the at least one second acrylate monomer is a mono-functional acrylate monomer.

Embodiment 5. The curable composition of any one of the preceding embodiments, wherein the at least one first acrylate monomer is a mono-functional acrylate monomer and the at least one second acrylate monomer is a mono-functional acrylate monomer.

Embodiment 6. The curable composition of any one of the preceding embodiments, wherein the at least one first acrylate monomer and the at least one second acrylate monomer each include a chemical group that includes a carbon-carbon double bond that is bonded to an ester functional group (—COOR), where R includes an alkyl group, an aromatic group, an alcohol, a cycloalkane group, a heterocyclic group, a bicyclic group, or any combination thereof.

Embodiment 7. The curable composition of any one of the preceding embodiments, wherein the at least first acrylate monomer, the at least one second acrylate monomer, or combination thereof is an aliphatic acrylate monomer.

Embodiment 8. The curable composition of any one of the preceding embodiments, wherein the at least one first acrylate monomer is an aliphatic acrylate monomer and the at least one second acrylate monomer is an aliphatic acrylate monomer.

Embodiment 9. The curable composition of any one of the preceding embodiments, wherein the at least one first acrylate monomer is a mono-functional aliphatic acrylate monomer and the at least one second acrylate monomer is a mono-functional aliphatic acrylate monomer.

Embodiment 10. The curable composition of any one of the preceding embodiments, wherein an amount of the at least one first acrylate monomer is at least 7 wt. %, or at least 10 wt. %, or at least 12 wt. %, or at least 15 wt. %, or at least 18 wt. %.

Embodiment 11. The curable composition of any one of the preceding embodiments, wherein an amount of the at least one first acrylate monomer is not greater than 19 wt. %, or not greater than 17 wt. %, or not greater than 15 wt. %, or not greater than 13 wt. %.

Embodiment 12. The curable composition of any one of the preceding embodiments, wherein an amount of the at least one second acrylate monomer is at least 27 wt. % based on the total weight if the curable composition, or at least 30 wt. %, or at least 35 wt. %, or at least 38 wt. %, or at least 40 wt. %.

Embodiment 13. The curable composition of any one of the preceding embodiments, wherein an amount of the at least one second acrylate monomer is not greater than 43 wt. % based on the total weight of the curable composition, or not greater than 40 wt. %, or not greater than 38 wt. %, or not greater than 35 wt. %, or not greater than 33 wt. %, or not greater than 30 wt. %.

Embodiment 14. The curable composition of any one of the preceding embodiments, wherein an amount of the tackifying agent is at least 33 wt. %, or at least 35 wt. %, or at least 38 wt. %, or at least 40 wt. %.

Embodiment 15. The curable composition of any one of the preceding embodiments, wherein an amount of the tackifying agent is not greater than 45 wt. %, or not greater than 42 wt. %, or not greater than 40 wt. %, or not greater than 37 wt. %.

Embodiment 16. The curable composition of any one of the preceding embodiments, wherein the tackifying agent includes a glycerol ester of gum rosin, a pentaerythritol ester of gum rosin, a methyl ester of gum rosin, an aromatic hydrocarbon resin, an aliphatic hydrocarbon resin, a mixed aliphatic/aromatic resin, a terpene resin, or any combination thereof.

Embodiment 17. The curable composition of embodiment 16, wherein the tackifying agent includes glycerol ester of gum rosin.

Embodiment 18. The curable composition of embodiment 17, wherein the tackifying agent consists essentially of glycerol ester of gum rosin.

Embodiment 19. The curable composition of any one of the preceding embodiments, wherein a ratio of the at least one second acrylate monomer to the at least one first acrylate monomer is at least 1.5, or at least 1.7, or at least 2.0, or at least 2.5, or at least 3.0.

Embodiment 20. The curable composition of any one of the preceding embodiments, wherein a ratio of the at least one second acrylate monomer to the at least one first acrylate monomer is not greater than 4.5, or not greater than 4.0, or not greater than 3.5, or not greater than 3.0, or not greater than 2.5, or not greater than 2.2.

Embodiment 21. The curable composition of any one of the preceding embodiments, wherein the first acrylate monomer includes 2-hydroxypropyl methacrylate, 2-hydroxyethyl methacrylate, methyl methacrylate, isobornyl methacrylate, tetrahydrofurfuryl methacrylate, benzyl methacrylate, isophoryl methacrylate, cyclohexyl methacrylate, or any combination thereof.

Embodiment 22. The curable composition of any one of the preceding embodiments, wherein the second acrylate monomer includes dodecyl methacrylate, isodecyl methacrylate, 2-ethyl-hexylacrylate, 2-ethylhexyl methacrylate, ethyltriglycol methacrylate, 2-phenoxyethyl methacrylate, or any combination thereof.

Embodiment 23. The curable composition of any one of the preceding embodiments, wherein the glass transition temperature of the homopolymer of the first acrylate monomer is at least 20° C., or at least 25° C., or at least 30° C., or at least 35° C., or at least 40° C., or at least 50° C., or at least 60° C.

Embodiment 24. The curable composition of any one of the preceding embodiments, wherein the glass transition temperature of the homopolymer of the first acrylate monomer is not greater than 150° C., or not greater than 140° C., or not greater than 130° C., or not greater than 120° C.

Embodiment 25. The curable composition of any one of the preceding embodiments, wherein the glass transition temperature of the homopolymer of the second acrylate monomer is not greater than 18° C., or not greater than 15° C., or not greater than 10° C., or not greater than 5° C., or not greater than 0° C., or not greater than −10° C., or not greater than −20° C., or not greater than −30° C., or not greater than −40° C.

Embodiment 26. The curable composition of embodiment 25, wherein the glass transition temperature of the homopolymer of the second acrylate monomer is at least −90° C., or at least −80° C., or at least −70° C., or at least −50° C.

Embodiment 27. The curable composition of any one of the preceding embodiments, wherein the curable composition further includes a wax.

Embodiment 28. The curable composition of embodiment 27, wherein the wax includes a microcrystalline wax, an alpha olefin wax, a paraffin wax, or any combination thereof.

Embodiment 29. The curable composition of embodiments 27 or 28, wherein an amount of the wax is at least 0.3 wt. %, or at least 0.5 wt. %, or at least 0.8 wt. %, or at least 1.0 wt. %.

Embodiment 30. The curable composition of any one of embodiments 27-29, wherein an amount of the wax is not greater than 3.0 wt. % based on the total weight of the curable composition, or not greater than 2.5 wt. %, or not greater than 2.0 wt. %, or not greater than 1.5 wt. %, or not greater than 1.0 wt. %.

Embodiment 31. The curable composition of any one of the preceding embodiments, wherein the curable composition further includes a light stabilizer.

Embodiment 32. The curable composition of embodiment 31, wherein the light stabilizer includes a hindered amine.

Embodiment 33. The curable composition of any one of the preceding embodiments, wherein the curable composition further includes a UV absorber.

Embodiment 34. The curable composition of embodiment 33, wherein the UV absorber includes hydroxyphenyl benzotriazole.

Embodiment 35. The curable composition of any one of the preceding embodiments, wherein the polymerization initiator includes benzoyl peroxide, methyl ethyl ketone peroxide, dibenzoyl peroxide, acetylacetone peroxide, and tert-butyl peroxy-3,5,5-trimethyl hexanoate, t-butyl peroctoate, t-butyl perbenzoate, cumene hydroperoxide, other peroxides, or any combination thereof.

Embodiment 36. The curable composition of any of the preceding embodiments, further including an accelerator.

Embodiment 37. The curable composition of embodiment 36, wherein the accelerator includes an aromatic tertiary amine, cobalt naphthenate, cobalt octoate, dimethylaniline, or any combination thereof.

Embodiment 38, The curable composition of any one of embodiments 1-34, wherein the polymerization intiator is a photoinitiator.

Embodiment 39. The curable composition of embodiment 38, wherein the polymerization initiator comprises an aromatic phenome, an alkyl phenone, a phosphine oxide, an anthroquinone, or a combination thereof.

Embodiment 40. A method of waterproofing a construction surface, the method including: a. applying a liquid layer of the curable composition according to any one of the preceding claims over the construction surface; b. allowing the curable composition to cure, to form a solid waterproofing layer; c. applying a layer of a hydratable cementitious composition over the waterproofing layer and hardening the hydratable cementitious composition to form a hardened concrete, wherein a peel adhesion between the hardened concrete and the waterproofing layer is from 3.0 to 50.0 pounds per linear inch (pli) or 0.525 to 8.756 Newtons per mm according to modified ASTM D903-98 (2017).

Embodiment 41. The method of embodiment 40, wherein the construction surface includes a soil-retention structure or a base slab.

Embodiment 42. The method of embodiment 41, wherein the soil-retention structure is selected from the group consisting of lagging, formwork, shotcrete, a diaphragm wall, or combination thereof.

Embodiment 43. The method of embodiment 42, wherein the base slab is selected from a mud slab, a concrete slab, a protection slab, crushed stone, or combination thereof.

Embodiment 44. The method of any one of embodiments 40-43, wherein the construction surface further includes at least one article protruding out of the construction surface, and wherein the step of applying a liquid layer of the curable composition over the construction surface further includes applying the liquid layer of the curable composition at a base of the at least one article protruding.

Embodiment 45. The method of embodiment 44, wherein the at least one article is selected from the group including a pipe, a steel reinforcement bar, a rock anchor, a screw, a pile cap, a concrete column, or any combination thereof.

Embodiment 46. The method of any one of the embodiments of 40-45, wherein the construction surface further includes a barrier layer disposed over the construction surface and wherein the step of applying a liquid layer of the curable composition includes applying the liquid layer of the curable composition over a surface of the barrier layer.

Embodiment 47. The method of embodiment 46, wherein the barrier layer includes a polyolefin, a polyester, a polyurethane, a styrenic block copolymer, a silicone, an ethylene-propylene diene monomer (EPDM), a geotextile, a bituminous composite, or a combination thereof.

Embodiment 48. The method of embodiment 46, wherein the barrier layer is a foam including a polyolefin, a polyester, a polyurethane, a polystyrene, an acrylic, a styrenic block copolymer, a silicone, a bituminous composite, or a combination thereof.

Embodiment 49. The method of any one of embodiments 40-48, wherein an average thickness of the liquid layer is at least 0.5 mm and not greater than 50 mm.

Embodiment 50. The method of any one of embodiments 40-49, wherein an average thickness of the liquid layer is at least 1 mm and not greater than 25 mm.

Embodiment 51. A below-grade waterproofing system made according to the method of any one of embodiments 40-50.

Embodiment 52. A waterproofing kit including (i) a first composition; and (ii) a second composition, wherein the first composition and/or the second composition include at least one first acrylate monomer, at least one second acrylate monomer, and at least one tackifying agent in an amount of at least 20 wt. % based on the total weight of the curable composition, and wherein a homopolymer of the at least one first acrylate monomer has a higher glass transition temperature than a respective glass transition temperature of a homopolymer of the at least one second acrylate monomer, and a weight percent ratio of the at least one first acrylate monomer to the at least one second acrylate monomer ranges from 1:1 to 1:5; wherein the first composition comprises a polymerization initiator, and the second composition is essentially free of the polymerization initiator.

Embodiment 53. The kit of embodiment 52, wherein the polymerization initiator includes benzoyl peroxide, methyl ethyl ketone peroxide, dibenzoyl peroxide, acetylacetone peroxide, and tert-butyl peroxy-3,5,5-trimethyl hexanoate, t-butyl peroctoate, t-butyl perbenzoate, cumene hydroperoxide, or any combination thereof.

Embodiment 54. The kit of any one of embodiments 52 to 53, wherein the kit further includes instructions for forming a curable composition by mixing the first composition and the second composition in a volume ratio of from 10:1 to 1:10, and forming a waterproofing layer after curing the curable composition, wherein the waterproofing layer has a shore A hardness of 15 to 98, such as 25 to 95, such as 28 to 95, or even 30 to 95.

Embodiment 55. The kit of any one of embodiments 52-54, wherein the first composition and/or the second composition further includes at least one additive selected from a pigment, a dispersant, an antioxidant, an UV absorber, a hindered amine light stabilizer, an adhesion promoter, a defoamer, a rheology modifier, an accelerator, an inhibitor, or any combination thereof.

Embodiment 56. A waterproofing article including a waterproofing layer disposed over at least a portion of a barrier layer, wherein the waterproofing layer is formed of the cured curable composition according to embodiments 1-39, and wherein the barrier layer is configured to provide a moisture barrier, a vapor barrier, or combination thereof.

Embodiment 57. The waterproofing article according to embodiment 56, further comprising any one of the following: (i) particulate layer disposed over on at least a portion of the waterproofing layer on a side opposite the first functional layer; (ii) a reinforcing layer overlying the first functional layer, opposite the backing layer; (iii) a second functional layer disposed over the reinforcing layer on a side opposite the first functional layer; or (iv) a polymeric layer disposed over at least a portion of the second functional layer and or the first functional layer, on a side opposite the reinforcing layer.

Embodiment 58. The waterproofing article according to any one of embodiments 56-57, wherein the barrier layer includes a film or a foam.

While the invention is described herein using a limited number of embodiments, these specific embodiments are not intended to limit the scope of the invention as otherwise described and claimed herein. Modifications and variations from the described embodiments exist. More specifically, the following examples are given as a specific illustration of embodiments of the claimed invention. It should be understood that the invention is not limited to the specific details set forth in the examples. All parts and percentages in the examples, as well as in the remainder of the specification, are by weight of the total liquid curing membrane composition, unless otherwise specified.

### Examples

Table 1 below lists formulas and properties of exemplary waterproofing compositions. Exemplary waterproofing compositions were prepared the following procedure. The first and second (meth)acrylate monomers, tackifier, and wax were mixed together and heated to about 65° C. to melt the wax and form a homogeneous solution. The solution was cooled to about 20° C. under stirring. Fillers, pigment, and/or fumed silica were added and dispersed under high shear. Remaining additives and tertiary amine were added and mixed about 5 minutes further to produce a uniform mixture.

Applications of exemplary waterproofing compositions were executed by the following procedure. Benzoyl peroxide powder, approximately 1 to 2% by weight of the exemplary waterproofing composition, was added into the exemplary waterproofing composition and mixed about 30 to 60 seconds to disperse and dissolve the benzoyl peroxide powder. The precise amount of benzoyl peroxide powder to be used was adjusted based on application temperature and desired cure speed of the waterproofing composition. Catalyzed material was poured out and drawn down as a film on release liner or coating onto a backing film and allowed to cure.

Shore A durometer was measured according to ASTM D2240-15(2021). Adhesion to post-cast concrete was measured according to modified ASTM D-903 by the following procedure. After application, the membrane was cured for 7 days at about 23° C., 50% RH. The membrane samples were cut into strips approximately 2 inches wide and 6 inches long. The membrane samples were assembled in an HDPL mold in a vertical orientation such that the air-facing side of the membrane as-applied faced the interior of the mold. Wet concrete was placed in the mold and against the membrane samples and allowed to cure for at least 7 days before testing according to ASTM D903-98(2017), but at a crosshead speed of 2 inches per minute, and at a 90 degree angle with respect to the plane ofthe sample.

The examples demonstrate a variety of monomers can be formulated with good adhesion to post-cast concrete when within specified composition ranges.

TABLE 1
Compositions and properties of examples.

| | Comp. | Comp. | | | | | | |
|---|---|---|---|---|---|---|---|---|
| Ingredient | Ex. 1 | Ex. 2 | Ex. 1 | Ex. 2 | Ex. 3 | Ex. 4 | Ex. 5 | Ex. 6 |
| 2-hydroxypropyl | 22.84 | 24.59 | 16.32 | 0 | 14.46 | 0 | 24.40 | 14.63 |
| methacrylate | | | | | | | | |
| (wt/wt. %) | | | | | | | | |
| Methyl | 0 | 0 | 0 | 0 | 0 | 14.46 | 0 | 0 |
| methacrylate | | | | | | | | |
| (wt/wt. %) | | | | | | | | |
| Isobornyl | 0 | 0 | 0 | 10.74 | 0 | 0 | 0 | 0 |
| methacrylate | | | | | | | | |
| (wt/wt. %) | | | | | | | | |
| Polyurethane | 0 | 23.59 | 0 | 0 | 0 | 0 | 0 | 0 |
| dimethacrylate | | | | | | | | |
| Rosin Ester | 40.0 | 0 | 28.56 | 32.22 | 41.45 | 41.45 | 43.47 | 43.15 |
| (wt/wt. %) | | | | | | | | |
| Dodecyl | 17.76 | 32.12 | 36.72 | 28.64 | 36.84 | 36.84 | 14.49 | 23.98 |
| methacrylate | | | | | | | | |
| (wt/wt. %) | | | | | | | | |
| 2-ethylhexyl | 0 | 0 | 0 | 0 | 0 | 0 | 14.49 | 14.39 |
| acrylate | | | | | | | | |
| (wt/wt. %) | | | | | | | | |
| Calcium | 15 | 16 | 0 | 0 | 0 | 0 | 0 | 0 |
| carbonate | | | | | | | | |
| (wt/wt. %) | | | | | | | | |
| Talc (wt/wt. %) | 0 | 0 | 10 | 20 | 0 | 0 | 0 | 0 |
| Fumed silica | 3 | 2.8 | 3 | 3 | 2.75 | 2.75 | 2.5 | 3 |
| (wt/wt. %) | | | | | | | | |
| Titanium | 0.5 | 0 | 1 | 1 | 0 | 0 | 0 | 0 |
| dioxide | | | | | | | | |
| (wt/wt.%) | | | | | | | | |
| Paraffin wax | 0.5 | 0.5 | 0.5 | 0.5 | 0.6 | 0.6 | 0.5 | 0.6 |
| (wt/wt. %) | | | | | | | | |
| UV Absorber | 0 | 0 | 2 | 2 | 2 | 2 | 0 | 0 |
| (wt/wt. %) | | | | | | | | |
| Hindered | 0 | 0 | 1.5 | 1.5 | 1.5 | 1.5 | 0 | 0 |
| Amine Light | | | | | | | | |
| Stabilizer | | | | | | | | |
| (wt/wt. %) | | | | | | | | |
| 4,N,N- | 0.4 | 0.4 | 0.4 | 0.4 | 0 | 0 | 0 | 0 |
| trimethylaniline | | | | | | | | |
| (wt/wt. %) | | | | | | | | |
| N-(2- | 0 | 0 | 0 | 0 | 0.4 | 0.4 | 0.25 | 0.25 |
| Hydroxyethyl)- | | | | | | | | |
| N-methyl-para- | | | | | | | | |
| toluidine | | | | | | | | |
| (wt/wt. %) | | | | | | | | |
| Shore A | 90 | ND | 50 | 30 | 40 | 35 | 90 | 60 |
| durometer | | | | | | | | |
| Glass transition | −4.93 | ND | −20.74 | −15.06 | −16.04 | −13.07 | −7.50 | −9.17 |
| temperature, | | | | | | | | |
| T_{mg} (° C.) | | | | | | | | |
| Adhesion to | 2.00 | 0.15 | 11.12 | 6.79 | 7.65 | 22.13 | 9.24 | 10.92 |
| post-cast | | | | | | | | |
| concrete (pli) | | | | | | | | |

The foregoing examples and embodiments were present for illustrative purposes only and not intended to limit the scope of the invention.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall there between.

What is claimed is:

1. A curable composition, comprising:
at least one first acrylate monomer;
at least one second acrylate monomer;
at least one tackifying agent in an amount of at least 20 wt % and no greater than 75 wt %, based on the total weight of the curable composition; and
at least one polymerization initiator;
wherein
a homopolymer of the at least one first acrylate monomer has a higher glass transition temperature than a respective glass transition temperature of a homopolymer of the at least one second acrylate monomer, and
wherein the curable composition has at least one of the following:
(i) a weight percent ratio of the at least one first acrylate monomer to the at least one second acrylate monomer in a range from 1:1 to 1:5, and/or
(ii) the at least one first acrylate monomer present in an amount of 5-30 wt % and the at least one second acrylate monomer in an amount of 20-45 wt % based on the total weight of the curable composition.

2. The curable composition of claim 1, wherein the at least one first acrylate monomer, the at least one second acrylate monomer, or a combination thereof comprises a mono-functional acrylate monomer.

3. The curable composition of claim 1, wherein the at least one first acrylate monomer and the at least one second acrylate monomer each comprises a chemical group that includes a carbon-carbon double bond that is bonded to an ester functional group (—COOR), where R includes an alkyl group, an aromatic group, an alcohol, a cycloalkane group, a heterocyclic group, a bicyclic group, or any combination thereof.

4. The curable composition of claim 1, wherein the at least one first acrylate monomer, the at least one second acrylate monomer, or a combination thereof comprise an aliphatic acrylate monomer.

5. The curable composition of claim 1, wherein an amount of the at least one first acrylate monomer is at least 7 wt %, or at least 10 wt %, or at least 12 wt %, or at least 15 wt %, or at least 18 wt %, and is not greater than 19 wt %, or not greater than 17 wt %, or not greater than 15 wt %, or not greater than 13 wt %.

6. The curable composition of claim 1, wherein an amount of the at least one second acrylate monomer is at least 27 wt % based on the total weight if the curable composition, or at least 30 wt %, or at least 35 wt %, or at least 38 wt %, or at least 40 wt %, and is not greater than 43 wt % based on the total weight of the curable composition, or not greater than 40 wt %, or not greater than 38 wt %, or not greater than 35 wt %, or not greater than 33 wt %, or not greater than 30 wt %.

7. The curable composition of claim 1, wherein an amount of the tackifying agent is at least 25 wt %, or at least 33 wt %, or at least 35 wt %, or at least 38 wt %, or at least 40 wt %, and not greater than 50 wt %, or not greater than 45 wt %, or not greater than 42 wt %, or not greater than 40 wt %, or not greater than 37 wt %.

8. The curable composition of claim 1, wherein the tackifying agent comprises a glycerol ester of gum rosin, a pentaerythritol ester of gum rosin, a methyl ester of gum rosin, an aromatic hydrocarbon resin, an aliphatic hydrocarbon resin, a mixed aliphatic/aromatic resin, a terpene resin, or any combination thereof.

9. The curable composition of claim 1, wherein a ratio of the at least one second acrylate monomer to the at least one first acrylate monomer is at least 1.5, or at least 1.7, or at least 2.0, or at least 2.5, or at least 3.0, and is not greater than 4.5, or not greater than 4.0, or not greater than 3.5, or not greater than 3.0, or not greater than 2.5, or not greater than 2.2.

10. The curable composition of claim 1, wherein the first acrylate monomer comprises 2-hydroxypropyl methacrylate, 2-hydroxyethyl methacrylate, methyl methacrylate, isobornyl methacrylate, tetrahydrofurfuryl methacrylate, benzyl methacrylate, isophoryl methacrylate, cyclohexyl methacrylate, or any combination thereof.

11. The curable composition of claim 1, wherein the second acrylate monomer comprises dodecyl methacrylate, isodecyl methacrylate, 2-ethyl-hexylacrylate, 2-ethylhexyl methacrylate, ethyltriglycol methacrylate, 2 phenoxyethyl methacrylate, or any combination thereof.

12. The curable composition of claim 1, wherein the glass transition temperature of the homopolymer of the first acrylate monomer is at least 20° C., or at least 25° C., or at least 30° C., or at least 35° C., or at least 40° C., or at least 50° C., or at least 60° C., and is not greater than 150° C., or not greater than 140° C., or not greater than 130° C., or not greater than 120° C.

13. The curable composition of claim 1, wherein the glass transition temperature of the homopolymer of the second acrylate monomer is at least −90° C., or at least −80° C., or at least −70° C., or at least −50° C. and is not greater than 18° C., or not greater than 15° C., or not greater than 10° C., or not greater than 5° C., or not greater than 0° C., or not greater than −10° C., or not greater than −20° C., or not greater than −30° C., or not greater than −40° C.

14. The curable composition of claim 1, wherein the curable composition further comprises a wax, a light stabilizer, a UV absorber, an accelerator, or a combination thereof.

15. The curable composition of claim 1, wherein the polymerization initiator comprises benzoyl peroxide, methyl ethyl ketone peroxide, dibenzoyl peroxide, acetylacetone peroxide, and tert-butyl peroxy-3,5,5-trimethyl hexanoate, t-butyl peroctoate, t-butyl perbenzoate, and cumene hydroperoxide, other peroxides or any combination thereof.

16. The curable composition of claim 14, wherein the accelerator comprises an aromatic tertiary amine, cobalt naphthenate, cobalt octoate, dimethylaniline, or any combination thereof.

17. The curable composition of claim 1, wherein the polymerization initiator is a photoinitiator.

18. The curable composition of claim 17, wherein the polymerization phoinitiator comprises an aromatic phenome, an alkyl phenone, a phosphine oxide, an anthroquinone, or a combination thereof.

19. A method of waterproofing a construction surface, the method comprising:
a. applying a liquid layer of the curable composition according to claim 1 over the construction surface;
b. allowing the curable composition to cure, to form a solid waterproofing layer;
c. applying a layer of hydratable cementitious composition over the waterproofing layer and hardening the hydratable cementitious composition to form a hardened concrete, wherein a peel adhesion between the hardened concrete and the waterproofing layer is from 3.0 to 50.0 pounds per linear inch (pli) or 0.525 to 8.756 Newtons per mm according to modified ASTM D903-98 (2017).

20. The method of claim 19, wherein the construction surface comprises a soil-retention structure or a base slab.

21. The method of claim 19, wherein the construction surface further comprises at least one article protruding out of the construction surface, and wherein the step of applying a liquid layer of the curable composition over the construction surface further comprises applying the liquid layer of the curable composition at a base of the at least one article.

22. The method of claim 19, wherein the construction surface further comprises a barrier layer disposed over the construction surface, and wherein the step of applying a liquid layer of the curable composition comprises applying the liquid layer of the curable composition over a surface of the barrier layer.

23. The method of claim 19, wherein the barrier layer is a film comprising a polyolefin, a polyester, a polyurethane, a polystyrene, an acrylic, a styrenic block copolymer, a silicone, ethylene propylene diene monomer, a geotextile, a bituminous composite, or a combination thereof.

24. The method of claim 19, wherein the barrier layer is a foam comprising a polyolefin, a polyester, a polyurethane, a polystyrene, an acrylic, a styrenic block copolymer, a silicone, a bituminous composite, or a combination thereof.

25. The method of claim 19, wherein the construction surface is selected from among concrete, metal, polyolefin, a polyester, a polyurethane, a polystyrene, polyvinylchloride, an acrylic, a styrenic block copolymer, a silicone, ethylene propylene diene monomer, a geotextile, or a bituminous composite, and
wherein upon curing, the cured composition exhibits an adhesion >3 pli or 3 to 100 pli, or 3 to 75 pli, or 3 to 60 pli, 3 to 50 pli, or 5-40 pli, according to ASTM D903-98(2017) to the construction surface on which it is applied.

26. A below-grade waterproofing system made according to the method of claim 19.

27. A waterproofing kit comprising: (i) a first composition; and (ii) a second composition, wherein
the first composition and/or the second composition comprise at least one first acrylate monomer, at least one second acrylate monomer, and at least one tackifying agent in an amount of at least 20 wt % and no greater than 75 wt %, based on the total weight of the curable composition, and
wherein a homopolymer of the at least one first acrylate monomer has a higher glass transition temperature than a respective glass transition temperature of a homopolymer of at least one second acrylate monomer,
wherein a curable composition, formed by mixing a portion of the first composition and a portion of the second composition, has at least one of the following:
(i) a weight percent ratio of the at least one first acrylate monomer to the at least one second acrylate monomer ranges from 1:1 to 1:5, and/or
(ii) the at least one first acrylate monomer present in an amount of 5-30 wt % and the at least one second acrylate monomer in an amount of 20-45 wt % based on the total weight of the curable composition, and
wherein the first composition comprises a polymerization initiator, and the second composition is essentially free of a polymerization initiator.

28. The waterproofing kit of claim 27, wherein the kit further comprises instructions for forming a curable composition by mixing the first composition and the second composition, and forming a waterproofing layer after curing the curable composition, wherein the waterproofing layer has a shore A durometer of 15 to 95, such as 25 to 95, or even 28 to 95.

29. The waterproofing kit of claim 27, wherein the first composition and/or the second composition further comprises at least one of a pigment, a dispersant, an antioxidant, an UV absorber, a hindered amine light stabilizer, an adhesion promoter, a defoamer, a rheology modifier, an accelerator, and an inhibitor.

30. A waterproofing article comprising a waterproofing layer disposed over at least a portion of a barrier layer, wherein the waterproofing layer is formed of the cured curable composition according to claim 1, and wherein the barrier layer is configured to provide moisture and/or vapor barrier.

31. The waterproofing article according to claim 30, further comprising a particulate layer disposed over at least a portion of the waterproofing layer on a side opposite the barrier layer.

32. The waterproofing article according to claim 30, wherein the barrier layer comprises a film or a foam.
